(19) United States
(12) Patent Application Publication
(10) Pub. No.: US 2015/0264383 A1
(43) Pub. Date: Sep. 17, 2015

(54) Block Copy Modes for Image and Video Coding

(71) Applicant: Mitsubishi Electric Research Laboratories, Inc., Cambridge, MA (US)

(72) Inventors: Robert A. Cohen, Somerville, MA (US); Anthony Vetro, Arlington, MA (US); Kazuo Sugimoto, Lexington, MA (US)

(73) Assignee: Mitsubishi Electric Research Laboratories, Inc., Cambridge, MA (US)

(21) Appl. No.: 14/212,943

(22) Filed: Mar. 14, 2014

(51) Int. Cl. H04N 19/513; H04N 19/13; H04N 19/91; H04N 19/61; H04N 19/44

(52) U.S. Cl. CPC H04N 19/513; H04N 19/61; H04N 19/44; H04N 19/91; H04N 19/13

(57) ABSTRACT

A method decodes blocks in pictures of a video in an encoded bitstream by storing previously decoded blocks in a buffer. The previously decoded blocks are displaced less than a predetermined range relative to a current block being decoded. Cached blocks are maintained in a cache. The cached blocks include a set of best matching previously decoded blocks that are displaced greater than the predetermined range relative to the current block. The bitstream is parsed to obtain a prediction indicator that determines whether the current block is predicted from the previously decoded blocks in the buffer or the cached blocks in the cache. Based on the prediction indicator, a prediction residual block is generated, and in a summation process, the prediction residual block is added to a reconstructed residual block to form a decoded block as output.

### FIELD OF THE INVENTION

This invention relates generally to coding images and videos, and more particularly to predicting blocks in an encoder.

### BACKGROUND OF THE INVENTION

In video coding, motion compensation and motion estimation are used to improve inter picture compression efficiency by locating blocks in previously coded pictures that are similar to a block being coded in a current picture. This concept has previously been extended to intra motion compensation or intra block copy methods, in which previously coded blocks in the current picture are searched for a best match to the current block, see Joint Video Team standards, JVT-C 151, and JCTVC-M0350.

A displacement vector indicating a location of the block is signaled in a coded bitstream. The displacement vector for intra coded pictures is similar to the motion vector used for inter coded pictures. That method is in a proposed amendment to the High Efficiency Video Coding (HEVC) video coding standard.

FIG. 1 shows an encoder 100 according to conventional video compression standards, such as HEVC, combined with the existing intra block copy method 110. Previously reconstructed blocks 155, typically stored in a memory buffer are searched using a search range 156 to find a matching block 157, which is a close match to a current block to be coded. A displacement vector 158 indicates the offset between the current video block and this matching block.

The previously reconstructed blocks 155 are also fed to other intra prediction processes 160 in the encoder. A prediction selector 165 selects either the output of other intra prediction processes, or a matching block output by the intra block copy search process, to be output as the prediction block 168.

The input video block and prediction block are input to a difference calculation 170, resulting in the prediction residual block 175. This prediction residual block is transformed 177, quantized 178, and entropy coded 179 to the output bitstream 195. If the output of the intra block copy search process is selected as the prediction block, then the displacement vector is also entropy coded to the output bitstream. The transformed and quantized prediction residual block is also inverse quantized 188 and inverse transformed 187 to output a reconstructed block 190. Reconstructed blocks are stored in the previously reconstructed block memory.

FIG. 2 shows a decoder 200 according to conventional video compression standards, such as HEVC, combined with the existing intra block copy method 210. The decoder parses and decodes 279 a bitstream 295, followed by an inverse quantization 288 and inverse transform 287 to obtain a quantized prediction residual block 275. The pixels in the prediction block 268 are added 270 to those in the inverse quantized prediction residual block to obtain a reconstructed block 290 for the output video 201, and the set of previously reconstructed block 255 stored in the memory buffer.

The prediction block is either the output of the intra block copy process 210 or the other intra prediction processes 260, based upon the prediction selector 265. The prediction selector makes its selection based on whether intra block copy was used by the encoder, as indicated by relevant information in the bitstream, such as the presence of a displacement vector 258. The displacement vector indicates to the intra block copy process where in the set of previously constructed blocks to obtain the prediction block 268 for the block currently being decoded.

The intra block copy method is especially advantageous when coding graphics or screen-content video material, in which the videos contain regions of identically-valued pixels or blocks, unlike captured pictures acquired by a camera, which contain sensor noise, reducing the chance of any block being numerically identical to a previously coded block. The disadvantage of the intra block-copy technique is that searching for a matching block can significantly increase the encoder complexity and memory requirements, depending upon the size of the search range.

In practical applications, the search range is therefore be limited, which constrains the search for matching blocks to only the blocks located in an immediate vicinity of the currently coded block. Another related method used a sliding window to look for strings, i.e., sequences of pixels, to match the set of pixels currently being coded, see JCTVC-L0303. The advantage of this string-matching method is that commonly occurring strings can be accessed throughout the coding of the entire picture. The disadvantage of that method is that when strings early in the picture or stored window of the picture are frequently matched, then a large portion of the decoded picture may have to be stored in memory.

Existing methods described in European Patent EP 1985124 apply a block weighting function based on pixel location relative to the current block. Those methods, however, are limited to being applied to adjacent or nearby blocks, or to blocks whose location is known relative to the current block. The type scaling and weighting is dependent on the pixel location relative to the block or blocks.

### SUMMARY OF THE INVENTION

The embodiments of the invention provide image and video coding methods that can be used in conjunction with intra block copy, without having the disadvantages related to the extending the search range or increasing the memory usage of the existing intra block copy and string matching methods.

The embodiments enable cache-dependent functions to be applied to the blocks during a search process. The problem addressed by this invention is that in order to avoid excessive encoder complexity and memory requirements, the currently proposed standard for the intra block copying method limits its search to a relatively small neighborhood of previously coded blocks or pixels. For computer-generated or screen-content pictures, this eliminates the opportunity for matching more distant blocks, terms of space and time, which may be an exact match to the current block.

The embodiments disclose a method for which, in addition for searching for matching blocks within this range of previously coded pixels, a cache maintaining a set of K best matching blocks while coding the previous blocks is also searched. The maintaining includes storing and deleting blocks based on matching criteria.

This method allows for the potential matching of additional blocks without extending the search range of the existing intra block copy method, and the method avoids the larger or entire picture frame memory requirements of existing string-matching methods.

A cost metric can be output by both the intra block copy search method and the cache search method in an encoder, and the method with the lowest cost can be selected for coding the current block. Methods for maintaining the cache can depend on several factors including, a distortion metric, cost function, duration of the block being present in the cache, texture content of blocks in the cache, and distance metrics among the blocks in the cache and blocks being encoded or decoded.

In addition to maintaining data from previously decoded blocks, the cache can also maintain one or more predefined blocks known by both the encoder and decoder. In addition, locations or coordinates of blocks can be maintained. One or more caches can be used to encode and decode different regions or blocks in a picture, and the multiple caches can be maintained based on the content of the block, location, or other parameters. When searching the cache or other blocks to find a match to the current block being encoded or decoded, a scaling, weighting, or other adjusting function can be applied to the block or blocks being matched. The function can incorporate information or metrics from blocks in the cache, as not all blocks in the cache may have location information associated with them, e.g., as in the case with the predefined blocks.

Both intra block copy method and blocks in the cache can operate on blocks having varied partition sizes. One or more of these methods described by the embodiments can be used instead of, or in addition to the existing intra prediction modes, e.g., the directional intra prediction modes.

### BRIEF DESCRIPTION OF THE DRAWINGS

FIG. 1 is a schematic of an encoder according to the prior art;

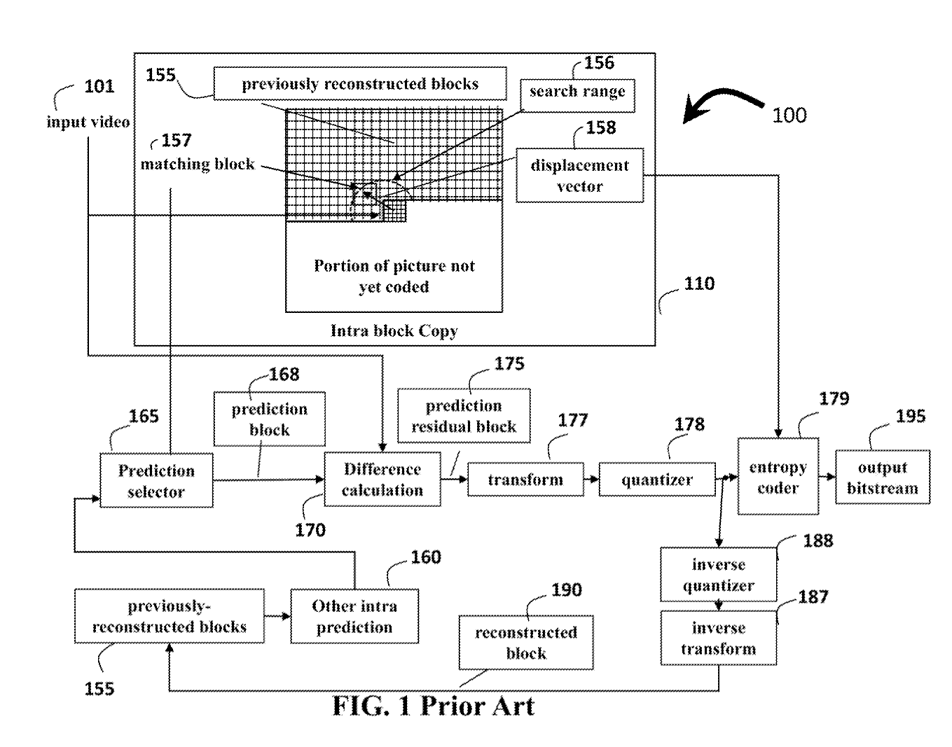

FIG. 2 is a schematic of a decoder according to the prior art;

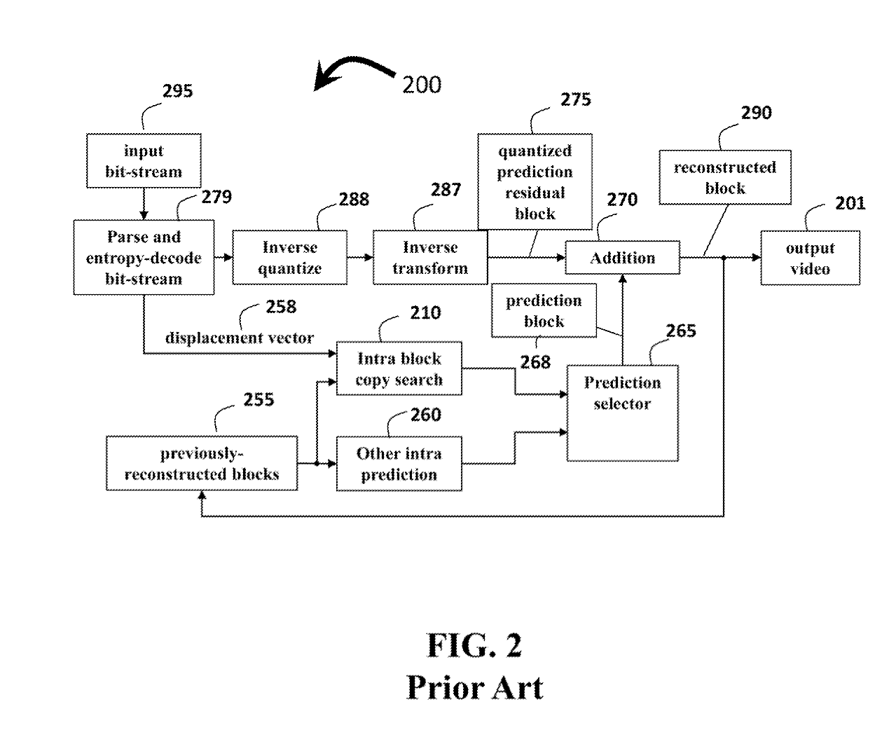

FIG. 3 is a schematic of an encoder according to embodiments of the invention;

FIG. 4 is a schematic of a decoder according to embodiments of the invention; and

FIG. 5 is a schematic of an encoder using combined caches with intra block copy according to embodiments of the invention.

### DETAILED DESCRIPTION OF THE PREFERRED EMBODIMENTS

Cache for a Set of the Best Previously Matched Blocks

The embodiments of our invention provide methods for coding pictures. Coding can comprise encoding and decoding. Generally, the encoding and decoding are performed in a codec (CODer-DECcoder. The codec is a hardware device, firmware, or computer program capable of encoding and/or decoding a digital data stream or signal. For example, the coder encodes a bitstream or signal for compression, transmission, storage or encryption, and the decoder decodes the encoded bitstream for playback or editing.

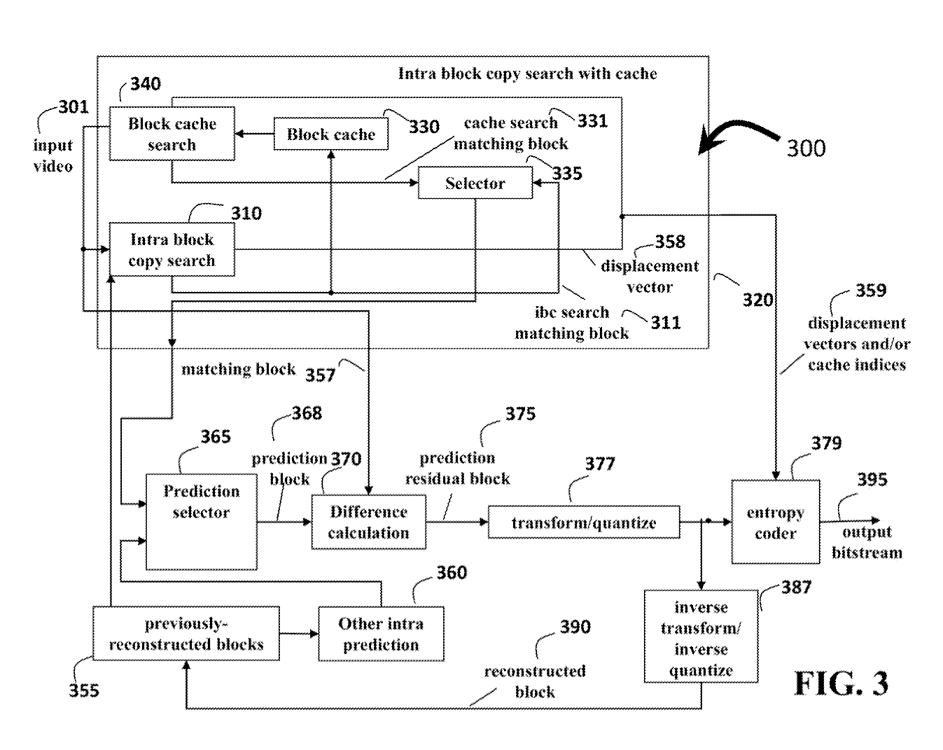

FIG. 3 shows a schematic of an encoder 300 according to the embodiments of the invention. The encoder can be implemented with a processor connected to memory and input/output interfaces by buses as known in the art.

Previously reconstructed blocks 355, typically stored in a memory buffer are searched in an intra block copy (ibc) search process 310 in order to determine a close ibc search matching block 311 to the current input video block 301 to be encoded according to matching criteria described below. A displacement vector 358 indicates the offset between the current input video block and the matching block.

A cache 330 contains K cached prediction blocks, where K can be in a range of 0 to a maximum cache size Kₘₐₓ. The input video block is also input to a block cache search 340. The block cache search compares cached prediction blocks in the cache to the input video block to determine which block in the cache is the best match to the current block.

Measures such as the sum of the absolution of pixel-wise differences between the input video block and a given block in the cache, the squared differences of these blocks, the average squared difference between these blocks, and other measures or cost functions can be used to select the best match from the cache.

The best matching block 311 from the block cache search and the best matching block from the intra block copy search are input to a selector 335, which selects which of these blocks is output as the final matching block 357 for the intra block copy with cache search process. If this matching block is selected from the intra block copy search, then a displacement vector is output 359 by the intra block copy with cache process. If the matching block is selected from the block cache search, then an index indicating an address of a block in the cache is output 359.

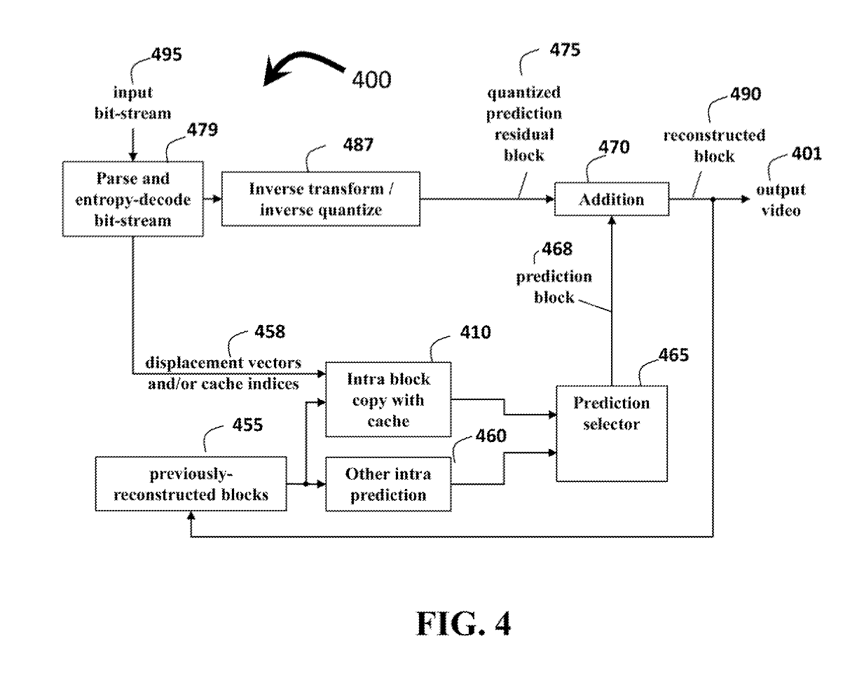

The selector 335 can also output a prediction indicator flag as part of the output 359 and output 458 described with respect to FIG. 4.

Previously reconstructed blocks 355 are also fed to other intra prediction process or processes 360 in the encoder. A prediction selector 365 selects either the output of the other intra prediction processes, or the matching block output by the intra block copy search with cache process, to be output as the prediction block 368.

The input video block and prediction block are input to a difference calculation 370, resulting in the prediction residual block 375. This prediction residual block is transformed and quantized 377, and then entropy coded 379 to the output bitstream 395. If the intra block copy method is selected as the prediction block, then the displacement vector or cache index is also entropy coded to the output bitstream.

The transformed and quantized prediction residual block is also inverse quantized and inverse transformed 387 to output a reconstructed block 390. Reconstructed blocks are stored in the previously reconstructed block memory.

A flag is signaled in the bitstream indicating whether the intra block copy search output or the block cache search was used. Alternatively, a specially-defined displacement value, such as zero or (0, 0) when the displacement vector is two-dimensional, can be signaled to indicate that the output of the block search was used.

When searching the previously reconstructed blocks, the location of the block being searched does not have to be aligned with the block locations of the previously reconstructed blocks. Thus, the search is similar to a pixel-wise sliding window.

FIG. 4 shows a decoder 400 according to the embodiments of the invention. The decoder parses and decodes 479 a bitstream 495, followed by an inverse quantization and inverse transform 487 to obtain a quantized prediction residual block 475. The pixels in the prediction block 468 are added 470 to those in the inverse quantized prediction residual block to obtain a reconstructed block 490 for the output video 401, and the set of previously reconstructed block 455 stored in the memory buffer.

The prediction block is either the output of the intra block copy with cache process 410 or the other intra prediction processes 460, based upon the prediction selector 465. The prediction selector makes a selection based upon whether the intra block copy with cache was used by the encoder, as indicated by relevant information in the bitstream, such as the presence of a displacement vector or cache index 458. The displacement vector indicates to the intra block copy process where in the set of previously constructed blocks to obtain the prediction block 468 for the block currently being decoded, and the cache index indicates which block in the cache in the intra block copy with cache process is output as the prediction block 468.

Maintain the Cache

The caches in the encoder and decoder are maintained in the same manner. When a new block is stored in the cache during the search process in the encoder, the decoder will also store the new block in the cache when the video is decoded. The block can be added to the cache either explicitly or implicitly.

In the explicit method, an add-to-cache flag is signaled in the bitstream indicating that the decoder is to add that block to the cache. The associated displacement vector can be used to identify the location of the block in the previously decoded block memory, after which the block is stored in the cache.

In another embodiment, the block is not copied from the previously decoded block memory, but a pointer or displacement vector to the location of the block in the previously decoded block memory is maintained, as long as that block remains in the previously decoded block memory. If the size of the previously decoded block memory is limited and a block corresponding to a displacement vector is going to be removed from memory, then at or before that time it can be copied to the cache.

In the implicit method, the decoder and encoder add a block to the cache when that block meets certain selection criteria. These criteria can include measuring a difference or distortion between the block and previously decoded blocks, or between the block and other blocks already in the cache. If that difference or distortion is less than a threshold, then the block can be added to the cache.

Alternative or additional criteria can include whether the block contains certain features, pixel values, colors, or structures. For example, if the cache contains primarily light-colored blocks (light in terms of pixel intensity), then new blocks can be added to the cache only if they are not light colored. Similarly, if the cache contains blocks with relatively smooth textures (in terms of intensity gradients), then new blocks can be added to the cache only when their textures exceed a certain threshold, e.g., as measured by the variance of the block. Adding blocks to the cache when they are below these thresholds is also possible, when it is desired that the cache maintains similar blocks.

In another embodiment, multiple caches can be maintained. Which cache to add a particular block can be indicated either by a flag or index signaled in the bitstream, or the need to add can be based on computations performed at the encoder and the decoder. For example, multiple caches can be defined so that each cache contains only blocks having a particular predetermined block size. Another example is that each cache can contain blocks having similar characteristics pixel values, such as a high-texture cache and a low-texture cache.

In the multiple-cache case, each cache can maintain its own maximum size limit Kₘₐₓ. Each cache can also have its own set of rules as to how maintain the cache, i.e., how to add blocks to the cache and how to remove blocks from the cache. For example, there can be a short-term cache that is small and contains only recently-used or recently-signaled blocks, and there can be a long-term cache that contains blocks over a longer period of time or over a larger spatial region.

If a block is intended to be added to the cache, but an identical block already exists in the cache, then the block is not added. A frequency of use counter can indicate the number of times a block in the cache is used. While processing current blocks during the encoding process, or when parsing blocks from the bitstream in the decoding process, if the number of times a block in the cache is used is below a specified threshold, then that block can be removed from the cache, making room for other blocks. This threshold can be a function of the number of input or output blocks already processed.

Additional parameters that can be used to determine whether to add or remove a block to or from the cache can include adding the K blocks with lowest distortion, when the distortion is measured when comparing the block to multiple previously decoded blocks, maintaining a histogram or count of the number of times each block or each characteristic of a block is used, and/or using a threshold on that number of times to decide whether to add or remove the block.

Predefined Blocks

Instead of, or in addition to adding previously signaled blocks to the cache, one or more predefined blocks can be maintained in the cache. For example, in a typical desktop computing environment, features such as title bars, icons, boundaries of windows, etc., generated by a computer graphics application, occur quite frequently. Predefined blocks that match these features can be added to the cache prior to, or during the encoding and decoding processes.

Instead of signaling a displacement vector as is done for the existing block copy method, an index can be signaled indicating which predefined block is used.

Additional examples of predefined blocks can include blocks with content that is common in computerized displays, such as all-white blocks, all-black blocks, or textures or color patterns common in graphic user interfaces (GUIs), such as icons or menu bar patterns. Similar to the above method, a cost metric can be used to determine whether a predefined block or a block matched via the prior-art block copy method is selected to code the current block.

Intra Block Copy with Adjustment

Conventional methods for scaling or weighting blocks do not consider the use of a block cache, as the blocks in the cache are not necessarily adjacent or near to the current block being decoded, and in fact, may not even be present in the picture or previous pictures being decoded.

Additional considerations must be applied to any scaling, weighting, or similar functions applied to blocks in the cache. Moreover, the cache according to the embodiments allows for additional functionality in such functions. For example, the functions can be used to control the maintenance of the cache. When performing the search for intra block copy, instead of directly comparing the searched block with the current block, a function ƒ(B) of the search block (the block in the previously decoded block memory to which the current block is being compared) can be applied prior to the comparison. For example, an offset or scaling factor can be applied to the current block prior to making the comparison. This function, however, is not limited to being a function of only the pixel values in the search block. This function can also use previously decoded data, including data stored in the cache.

For example, an average block representing the pixel-wise average value of among some or all of the blocks currently in the cache can be determined. Then, this average block can be used to determine an offset or scaling for the function ƒ(B). For the case of the offset, the average of the value of the block being searched can be determined, and the average value of the average block can be determined, and the difference between these two averages can be an offset which is added to or subtracted from all the pixels in the block being searched, via the function ƒ(B). In another embodiment, the function is applied to the current block instead of or in addition to the block being searched.

Combined Cache and Modified Intra Block Matching

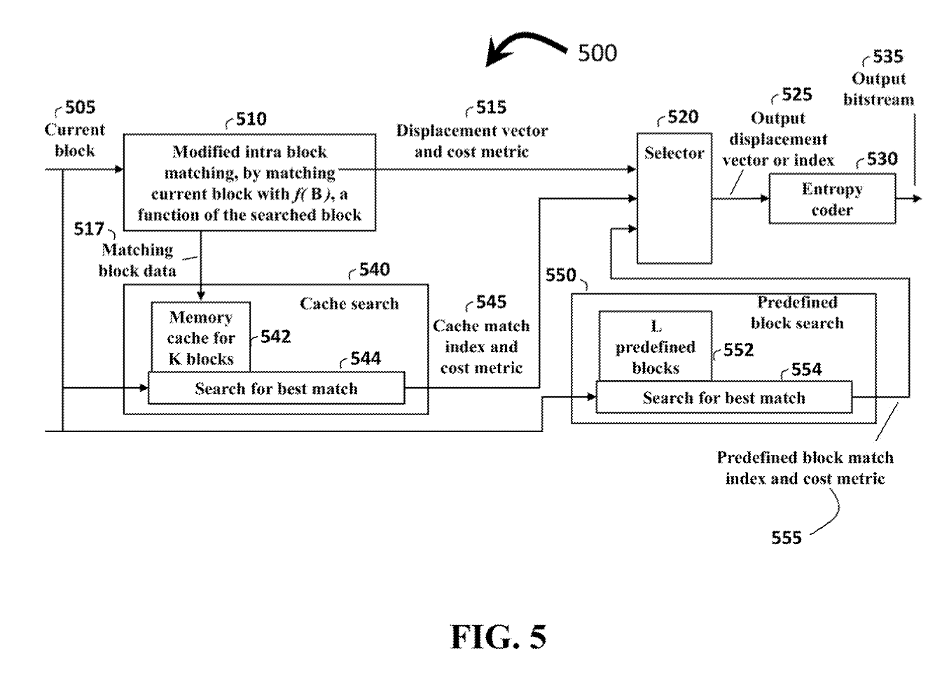

FIG. 5 shows an example of an encoder 500 that combines two or more of the methods described in this invention. The current block is modified by a function ƒ(B) prior to intra block matching in a modified intra block matching process 510. One or more matching blocks 517 output by the intra block matching process are stored in a cache 542. The blocks currently in the cache are also compared to the current block in a cache search process 540, and the best matching block and associated index 545 is output by the cache search process 544.

Similarly, a set of L predefined blocks 552 are searched 554, and the best matching block 555 is output from that predefined block search process 550. A selector 520 selects the best matching block output from all these search processes, in one embodiment by selecting the block that produces the lowest rate-distortion cost or lowest distortion when compared to the current block. A displacement vector or cache index 525 indicating which block to use is output to the entropy coder 530 for output to the bitstream 535. When implemented in the decoder, the decoder parses this displacement vector or cache index from the bitstream to determine which block to pass as the prediction block 468 to the addition process 470 of FIG. 4.

Storing the Locations of Blocks

In addition to storing decoded blocks as cached prediction blocks in the cache, the location or coordinates of each block in the decoded picture, or the displacement vector, can also be stored. This location information can be used to organize data in the cache or among multiple caches, or it can be used during the cache search process.

In an example of using the location to organize data, the cache or caches can group blocks based upon a region of the picture where the blocks appear. For example, the left side of a picture or video may contain computer graphics images, and the right side of a picture or video may contain text. The cache or caches can then separate data based upon the location of their contained blocks in the picture, and then the search process for subsequent blocks can be limited to the corresponding cache, depending upon what region of the picture the subsequent blocks appear.

An example of using the location information during the cache search process is when the location in the picture of the block being searched in the cache is far from the current block (in terms of space and time), then a weighting can be applied to either the pixel values in the block or to a cost or distortion measure. Additionally, a block can be removed from the cache when its location in the picture relative to the location of the current block is greater than a threshold.

Partitioning of Blocks

In the current HEVC proposed standard, inter coded blocks have more block partitioning types available when compared to intra coded blocks. For example, asymmetric partitions such as nL×2N and nR×2N are available for inter blocks, whereas intra blocks are limited to square partitions such as 2N×2N or N×N.

Given that intra block copy mode is modeled after the motion compensation method for inter pictures, it is desirable to allow for additional partition sizes such as nL×2N and nR×2N when performing intra block copy on intra blocks.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A method for decoding a bitstream, wherein the bitstream includes compressed pictures of a video, wherein each picture includes one or more blocks, comprising the steps of:
storing previously decoded blocks in a buffer, wherein the previously decoded blocks are displaced less than a predetermined range relative to a current block being decoded;
maintaining cached blocks in a cache, wherein the cached blocks include a set of best matching previously decoded blocks that are displaced greater than the predetermined range relative to the current block;
parsing the bitstream to obtain a prediction indicator, wherein the prediction indicator determines whether the current block is predicted from the previously decoded blocks in the buffer or the cached blocks in the cache;
generating, based on the prediction indicator, a prediction residual block; and
adding, in a summation process, the prediction residual block to a reconstructed residual block to form a decoded block as output, wherein the steps are performed in a decoder.

2. The method of claim 1, wherein the prediction indicator is a displacement vector for the buffer or a cache index for the cache.

3. The method of claim 1, further comprising:
maintaining the cached blocks explicitly or implicitly.

4. The method of claim 3, wherein the explicit maintaining is signaled in the bitstream, and an associated displacement vector identifies a location of the previously decoded block in the buffer.

5. The method of claim 3, wherein the implicit maintaining is based on a difference in distortion between the current block and the previously decoded blocks and the cached blocks.

6. The method of claim 3, wherein implicit maintaining is based on pixel values of the cached blocks.

7. The method of claim 1, wherein multiple caches are maintained.

8. The method of claim 7, wherein a particular cache to be used for the current block is signaled in the bitstream.

9. The method of claim 7, wherein the multiple caches are maintained based on sizes of the blocks.

10. The method of claim 7, wherein the multiple caches are maintained based pixel values.

11. The method of claim 7, wherein the multiple caches include a short-term cache and a long-term cache.

12. The method of claim 1, wherein the cache is maintained based of a frequency of use of the cached blocks.

13. The method of claim 1, wherein the cached blocks includes predefined blocks.

14. The method of claim 13, wherein the predefined blocks are generated by a computer graphics application.

15. The method of claim 13, wherein the predefined blocks are generated according to a cost function.

16. The method of claim 1, wherein one or more scaling or weighting functions are applied to the cached blocks.

17. The method of claim 16, wherein the one or more weighting or scaling function are applied to the current block.

18. The method of claim 1, further comprising:
storing locations or displacement vectors associated with the cached prediction block in the cache.

19. The method of claim 2, wherein if the displacement vector is zero, then the prediction indicator is inferred to indicate that the current block is predicted from the cached blocks, and if the displacement vector is nonzero, then the prediction indicator is inferred to indicate that the current block is predicted from the previously decoded blocks in the buffer.

20. The method of claim 1, further comprising:
maintaining the cache based on locations or displacement vectors of the blocks.
